(19) United States
(12) Patent Application Publication
(10) Pub. No.: US 2020/0234326 A1
(43) Pub. Date: Jul. 23, 2020

(54) TEMPORAL DISPOSITION OF OFFERS BASED ON DECAY CURVES

(71) Applicant: Mercari, Inc., Palo Alto, CA (US)

(72) Inventor: John LAGERLING, Los Altos Hills, CA (US)

(73) Assignee: Mercari, Inc., Palo Alto, CA (US)

(21) Appl. No.: 16/253,719

(22) Filed: Jan. 22, 2019

(51) Int. Cl. G06Q 30/02

(52) U.S. Cl. CPC G06Q 30/0235

(57) ABSTRACT

Disclosed herein are system, apparatus, device, method and/or computer program product embodiments, and/or combinations and sub-combinations thereof, for temporal disposition of offers based on decay curves. In an embodiment, a server comprises: a plurality of listings associated with categories; a decay curve database storing a plurality of category decay curves and a plurality of user decay curves; and at least one processor configured to: monitor user activity of the server; and generate the category decay curves and the user decay curves using the monitored user activity.

### BRIEF DESCRIPTION OF THE FIGURES

The accompanying drawings are incorporated herein and form a part of the specification.

FIG. 1 illustrates a computing environment, according to some embodiments.

FIGS. 2 and 3 illustrate example decay curves, according to some embodiments.

FIG. 4 illustrates a flowchart of a method for temporal disposition of offers based on decay curves, according to some embodiments.

FIG. 5 illustrates an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, apparatus, device, method and/or computer program product embodiments, and/or combinations and sub-combinations thereof, for temporal disposition of offers based on decay curves.

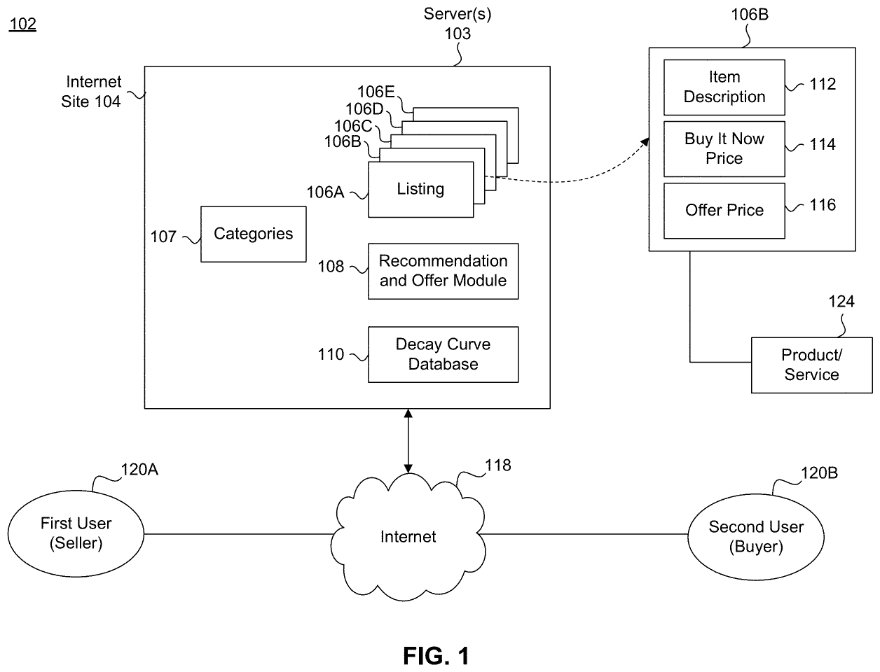

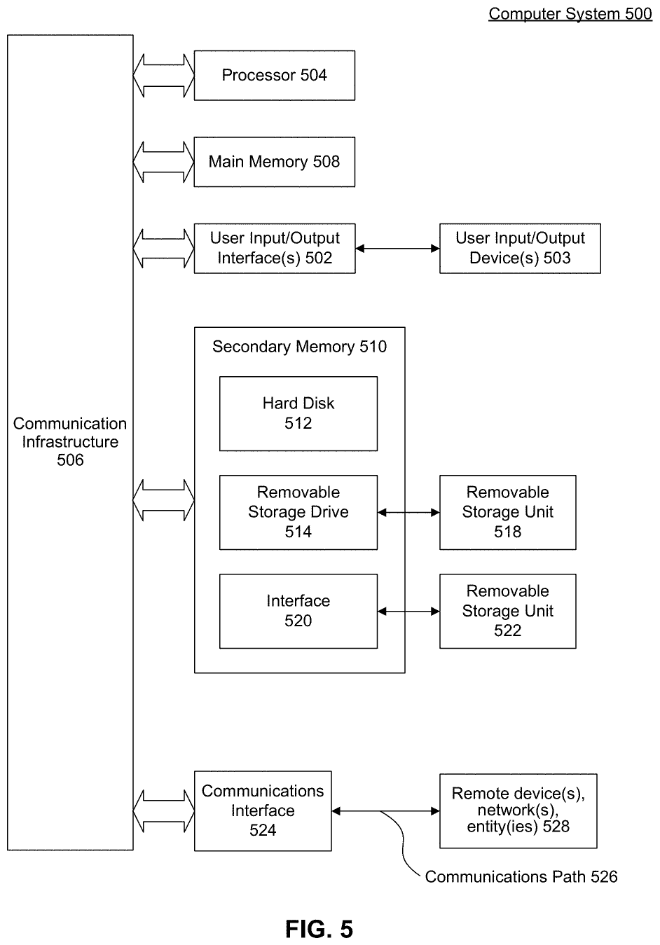

FIG. 1 illustrates a computing environment 102 having one or more servers 103, which may be implemented using computer systems 500 such as shown in FIG. 5 (and further described below). An internet site 104 executes using the servers 103.

The servers 103 may be configured to communicate via the Internet 118. Users 120 may access and interact with the servers 103 and the internet site 104 via the Internet 118.

In some embodiments, site 104 enables users 120 to buy and sell products and/or services. Examples of site 104 include MERCARI.COM, AMAZON.COM, EBAY.COM, CRAIGSLIST.COM, etc., to name just some examples.

Some users 120, such as a first user 120A, may create listings 106 on the site 104 to sell their new or used belongings. Other users 120, such as a second user 120B, may browse and search listings 106 to find items of interest to purchase. At any given time, a given user 120 may be selling and/or buying products and/or services using the site 104 (that is, a given user 120 may be a seller or a buyer on the site 104).

Each listing 106 may include an item description 112 that describes an associated product/service 124 that is being offered for sale. The products/services 124 may be organized into categories 107, such as clothing, furniture, tools, electronics, fine art, etc. The item description 112 may indicate the category 107 of the listing 106. Each listing may also include a “buy it now” (BIN) price 114 and an offer price 116.

A user 120, such as the second user 120B, who is viewing a given listing 106 (such as listing 106B) may immediately purchase the associated product/service 124 by agreeing to the BIN price 114. Alternatively, the second user 120B may enter an offer (that is, the second user 120B may enter an offer price 116) for the product/service 124. The second user 120B's offer price 116 would be lower than the BIN price 114 (otherwise, the second user 120B would immediately purchase the product/service 124 by agreeing to the BIN price 114).

The user 120, such as the first user 120A, who created the listing 106B can either accept or reject the offer price 116. Over time, if the product/service 124 does not sell, the first user 120A may reduce the BIN price 114, and/or may be more willing to agree to lower offer prices 116 from the second user 120B (as well as other users 120).

Ideally, the second user 120B would like to enter the lowest possible offer price 116 that would be acceptable to the first user 120A in order to purchase the product/service 124. But, the offer price 116 that the first user 120A is willing to accept may vary according to a number of factors, such as the length of time the product/service 124 has been listed (that is, the age of the listing 106, which is the amount of time from when the listing 106 was created, to when the product/service 124 associated with the listing 106 was sold on the site 104), and the category 107 of the product/service 124. For example, the longer the product/service 124 has been listed, the more willing the first user 120A may be to accept lower offer prices 116. Also, the first user 120A may be more willing to accept lower offer prices 116 for some categories 107 of products/services 124 (such as used clothing and used furniture) as compared to other categories 107 of products/services 124 (such as high end electronics and fine art).

Also, the offer price 116 that users 120 find acceptable may vary among users 120. For example, some users 120 may be naturally inclined to accept lower offer prices 116 than other users 120.

But, prior to this disclosure, no technology existed for assisting a user 120 (such as the second user 120B) to determine an offer price 116 that would likely be agreeable to the user 120 (such as the first user 120A) who listed the product/service 124 in question, that takes into consideration (1) the age of the listing 106; (2) the category 107 of the product/service 124; and/or (3) the user 120 who created the listing 106 and is selling the product/service 124.

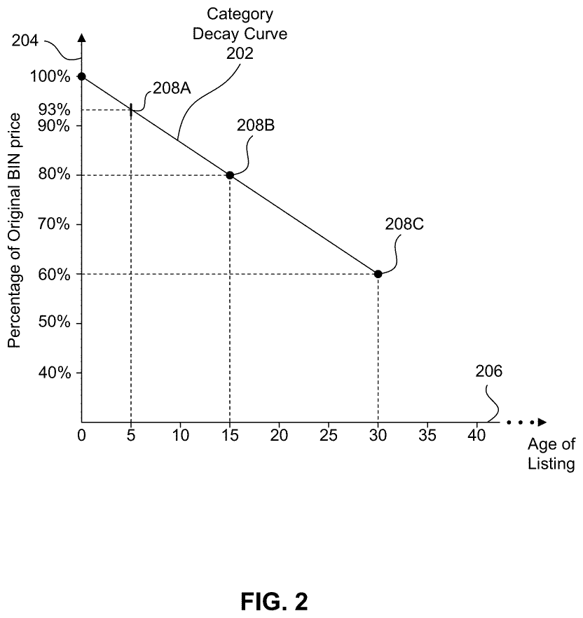

Accordingly, embodiments of this disclosure are directed to the temporal disposition of offers based on decay curves. FIG. 2 illustrates an example decay curve 202. In some embodiments, each decay curve 202 corresponds to a category 107 of products/services that are sold via the internet site 104, such as clothing, furniture, tools, electronics, art, etc. Accordingly, decay curves 202 may also be called herein category decay curves 202.

The site 104 may include a recommendation and offer module 108 that generates the category decay curves 202. The category decay curves 202 may be stored in a decay curve database 110.

In some embodiments, for each category 107, the recommendation and offer module 108 keeps track of products and services 124 that have sold via the site 104. For example, for each listing 106 in a given category 107 that has sold, the recommendation and offer module 108 may keep track of the original BIN price 114 of the listing 106, the price at which the associated product/service 124 eventually sold, and the age of the listing 106 when the associated product/service 124 eventually sold.

The recommendation and offer module 108 may use this information to generate a category decay curve 202 for each category 107. In some embodiments, the category decay curve 202 shows, for a given category 107, the prices at which sellers (such as the first user 120A) were willing to sell their products/services 124 over time (where time is based on the age of the listing 106 when the product/services 124 sold). Put another way, the category decay curve 202 shows the offer prices 116 that sellers were willing to agree to, based on the age of the listing 106.

In the example of FIG. 2, category decay curve 202 shows that when listings 106 in a given category 107 are created (that is, age of listing equals 0), sellers were willing to sell only at 100% of the original BIN price 114. However, within 5 days after listings 106 were created, at least some sellers were willing to sell their products/services 124 at 93% of the original BIN price 114 (this is indicated by 208A). At 15 days after the listing 106 was created, some sellers were willing to sell their products/services 124 at 80% of the original BIN price 114 (this is indicated by 208B). At 30 days after the listing 106 was created, some sellers were willing to sell their products/services 124 at 60% of the original BIN price 114 (this is indicated by 208C).

Each of these points 208—which may be called decay points 208 herein—may be generated by averaging the sales data collected by the recommendation and offer module 108 at particular listing ages, and/or at particular percentages of the original BIN price 114. For example, supposed at listing age=15 days, there were 5 sales (in the category 107 associated with category decay curve 202) at the following percentages of the original BIN price 114: 100%, 90%, 80%, 70% and 60%. The recommendation and offer module 108 would thereby determine the average of these percentages to be 80%, and thus create decay point 208B of 80% in the category decay curve 202.

In some embodiments, the number of sales must be greater than a threshold over a predetermined time period in order to generate a decay point 208. The predetermined time period may be 1 month, 3 months, or any other time period. Referring again to the example of FIG. 2, and for the predetermined time period, if this threshold is 10, then the recommendation and offer module 108 would not create the decay point 208B since the number of sales (5) are less than the threshold (10).

As just described, in some embodiments, category decay curves 202 are associated with categories 107. In other embodiments, the recommendation and offer module 108 also tracks seller activity. For example, for each listing 106 created by a given user 120 that sold, the recommendation and offer module 108 may keep track of the original BIN price 114 of the listing 106, reductions in the BIN price 114 by the user 120, when the reductions occurred (measured from the age of the listing 106), the price at which the associated product/service 124 eventually sold, and the age of the listing 106 when the associated product/service 124 eventually sold.

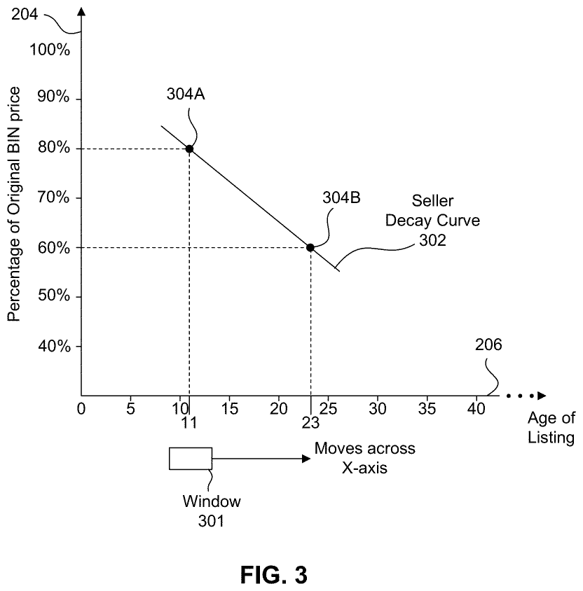

The recommendation and offer module 108 may use this information to generate a seller decay curve 302 for the user 120 in question (see FIG. 3). In some embodiments, the seller decay curve 302 may show, for each user 120, the percentages by which the user 120 reduced the BIN price 114, and the times (in terms of the age of the listing 106) such reductions occurred. The seller decay curve 302 may also show the percentages off the original BIN price 114 that the user 120 accepted offers 116, and the times such acceptances occurred.

For example, the illustrative seller decay curve 302 in FIG. 3 shows that the associated user 120 (for whom the curve 302 applies) has a history of selling at 80% of the original BIN price 114 at 11 days after creating listings 106 (see point 304A), and at 60% at 23 days (see 304B).

Each of these points 304—which may be called seller reduction points 304 herein—may be generated by averaging the sales data collected by the recommendation and offer module 108 at particular listing ages, and/or at particular percentages of the original BIN price 114. For example, supposed at listing age=10 days, the user 120 reduced the BIN price 114 to 90% of the original BIN price 114 in a first listing, and at listing age=12 days, the user 120 accepted an offer price 116 that was at 70% of the original BIN price 114 in a second listing. In this case, the recommendation and offer module 108 may create a seller reduction point 304A of 80% (that is, the average of 90% and 70%) at a listing age of 11 days (that is, the average of 10 and 12).

In some embodiments, the recommendation and offer module 108 may analyze sales of the user 120 as just described, by moving across the X axis using a window 301 of a predetermined size. The window 301 may have a length of 5 days (as shown in the example of FIG. 3), 10 days, or any other time period. The recommendation and offer module 108 may analyze sales data of the user 120 to determine if a seller reduction point 304 should be created in the window 301, as the window 301 steps across the X axis in 1 day increments (or any other increment).

In some embodiments, the number of sales in the window 301 must be greater than a threshold over a predetermined time period in order to generate a seller reduction point 304 in the current position of the window 301. The predetermined time period may be 1 month, 3 months, or any other time period. Referring again to the example of FIG. 3, assume the window 301 is currently positioned over days 9 to 13 of the X-axis, and the threshold is 10. In this case, the recommendation and offer module 108 would not create the seller reduction point 304A since the number of sales (2) are less than the threshold (10) within the window 301 as currently positioned on the X-axis.

In some embodiments, a single seller decay curve 302 may be generated for a given user 120 that covers all the categories 107. In other embodiments, multiple seller decay curves 302 may be generated for a given user 120, with each seller decay curve 302 covering one of the categories 107.

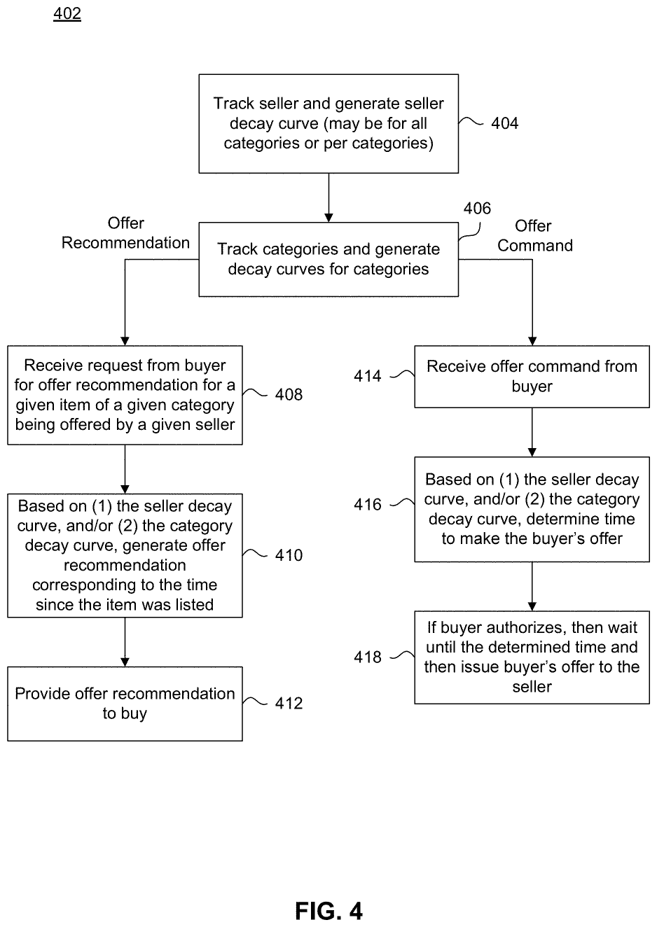

FIG. 4 is a flowchart for a method 402 for temporal disposition of offers based on decay curves, according to an embodiment. Method 402 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 4, as will be understood by a person of ordinary skill in the art. Method 402 shall be described with reference to FIGS. 1-3. However, method 402 is not limited to those example embodiments.

In 404, the recommendation and offer module 108 may generate seller decay curves 302 for users 120, as discussed above. The seller decay curves 302 may be stored in the decay curve database 118.

In 406, the recommendation and offer module 108 may generate category decay curves 202, as discussed above. The category decay curves 202 may be stored in the decay curve database 118.

From 406, a user 120 (such as second user 120B) who is interested in a listing 106 (such as listing 106B) may request the site 104 to provide an offer recommendation. The listing 106 may be associated with a product/service 124 in a given category 107 that a given user 120 (such as the first user 120A) is trying to sell via site 104. This is indicated by 408.

In 410, the recommendation and offer module 108 may generate an offer recommendation, based on (1) the seller decay curve 302 of the first user 120A; and/or (2) the category decay curve 202 corresponding to the category 107 of the listing 106B.

For example, assume the current age of the listing 106B is 15 days, and the example category decay curve 202 of FIG. 2 corresponds to the category 107 of the listing 106B in question. In this case, based on the category decay curve 202, the recommendation and offer module 108 may recommend an offer price 116 of 80% of the original BIN price 114 at the listing age of 15 days.

Now also assume that the example seller decay curve 302 in FIG. 3 applies to the user 120 who created the listing 106B (that is, the first user 120A). In this case, based on the seller decay curve 302, the recommendation and offer module 108 may recommend an offer price 116 of 73% of the original BIN price 114 at the listing age of 15 days.

If both the seller decay curve 302 and category decay curve 202 are being used in 410, then the recommendation and offer module 108 may average the results to thereby recommend an offer price 116 of 76.5% of the original BIN price 114 at the listing age of 15 days (this may be called a blended offer price recommendation). However, other approaches may be used to generate a blended recommendation or to take other action. For example, for categories 107 that retain most of their value at the listing age of interest (that is, for categories having a flat category decay curve 202 at the listing age of interest), the recommendation and offer module 108 may provide more weight (such as twice the weight, or any other predetermined weight) to the category decay curve 202, as compared to the seller decay curve 302, to generate a recommended offer price 116. Alternatively, the recommendation and offer module 108 may provide (that is, display) the range (that is, 73% to 80% of the original BIN price 114) to the second user 120B, and request that the second user 120B select an offer price 116 based on this information.

In 412, the recommendation and offer module 108 provides (that is, displays) the recommended offer price 116 from 410 to the second user 120B.

Referring back to 406, a user 120 (such as second user 102B) who is interested in a listing 106 (such as listing 106B) may issue an offer command (of a particular offer price 116) to the site 104. This is indicated by 414. The listing 106 may be associated with a product/service 124 in a given category 107 that a given user 120 (such as the first user 120A) is trying to sell via site 104. The offer command instructs the site 104 to offer the first user 120A the offer price 116 for the listing 106B.

In 416, the recommendation and offer module 108 determines the best time to make the offer to the first user 120A based on (1) the seller decay curve 302 of the first user 120A; and/or (2) the category decay curve 202 corresponding to the category 107 of the listing 106B.

For example, assume the offer price 116 is 80% of the original BIN price 114, and the second user 120B issues the offer command at age of listing=5 days. Also assume the example seller decay curve 302 of FIG. 3 applies to the first user 120A, and the example category decay curve 202 in FIG. 2 applies to the category 107 of the listing 106B in question. In this case, the seller decay curve 302 would indicate that day 11 or greater would be the best time to make the offer to the first user 120A. In contrast, the category decay curve 202 would indicate that day 15 or greater would be the best time to make the offer to the first user 120A.

In some embodiments, the recommendation and offer module 108 may provide this range (that is, day 11 to day 15) to the second user 120B, and request the second user 120B to select a day to make the offer to the first user 120A. Alternatively, the recommendation and offer module 108 may automatically select a day to make the offer by averaging the two days (that is, an average of 13 in the above example), or take the greater of the two days (that is, day 15), or any other approach that would be apparent to persons skilled in the relevant art(s) based on the teachings of this disclosure.

In 418, the recommendation and offer module 108 automatically issues the offer to the first user 120A on the day determined in 416.

### Example Computer System

Various embodiments and/or components therein can be implemented, for example, using one or more computer systems, such as computer system 500 shown in FIG. 5. Computer system 500 can be any computer or computing device capable of performing the functions described herein. For example, one or more computer systems 500 or portions thereof can be used to implement any embodiments of FIGS. 1-3, and/or any combination or sub-combination thereof.

Computer system 500 includes one or more processors (also called central processing units, or CPUs), such as a processor 504. Processor 504 is connected to a communication infrastructure or bus 506.

One or more processors 504 can each be a graphics processing unit (GPU). In some embodiments, a GPU is a processor that is a specialized electronic circuit designed to process mathematically intensive applications. The GPU can have a parallel structure that is efficient for parallel processing of large blocks of data, such as mathematically intensive data common to computer graphics applications, images, videos, etc.

Computer system 500 also includes user input/output device(s) 503, such as monitors, keyboards, pointing devices, etc., that communicate with communication infrastructure 506 through user input/output interface(s) 502.

Computer system 500 also includes a main or primary memory 508, such as random access memory (RAM). Main memory 508 can include one or more levels of cache. Main memory 508 has stored therein control logic (i.e., computer software) and/or data.

Computer system 500 can also include one or more secondary storage devices or memory 510. Secondary memory 510 can include, for example, a hard disk drive 512 and/or a removable storage device or drive 514. Removable storage drive 514 can be a floppy disk drive, a magnetic tape drive, a compact disk drive, an optical storage device, tape backup device, and/or any other storage device/drive.

Removable storage drive 514 can interact with a removable storage unit 518. Removable storage unit 518 includes a computer usable or readable storage device having stored thereon computer software (control logic) and/or data. Removable storage unit 518 can be a floppy disk, magnetic tape, compact disk, DVD, optical storage disk, and/any other computer data storage device. Removable storage drive 514 reads from and/or writes to removable storage unit 518 in a well-known manner.

According to an exemplary embodiment, secondary memory 510 can include other means, instrumentalities or other approaches for allowing computer programs and/or other instructions and/or data to be accessed by computer system 500. Such means, instrumentalities or other approaches can include, for example, a removable storage unit 522 and an interface 520. Examples of the removable storage unit 522 and the interface 520 can include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 500 can further include a communication or network interface 524. Communication interface 524 enables computer system 500 to communicate and interact with any combination of remote devices, remote networks, remote entities, etc. (individually and collectively referenced by reference number 528). For example, communication interface 524 can allow computer system 500 to communicate with remote devices 528 over communications path 526, which can be wired and/or wireless, and which can include any combination of LANs, WANs, the Internet, etc. Control logic and/or data can be transmitted to and from computer system 500 via communication path 526.

In some embodiments, a non-transitory, tangible apparatus or article of manufacture comprising a tangible computer useable or readable medium having control logic (software) stored thereon is also referred to herein as a computer program product or program storage device. This includes, but is not limited to, computer system 500, main memory 508, secondary memory 510, and removable storage units 518 and 522, as well as tangible articles of manufacture embodying any combination of the foregoing. Such control logic, when executed by one or more data processing devices (such as computer system 500), causes such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 5. In particular, embodiments can operate with software, hardware, and/or operating system implementations other than those described herein.

### CONCLUSION

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

What is claimed is:

1. A server, comprising:
a plurality of listings associated with categories;
a decay curve database storing a plurality of category decay curves and a plurality of user decay curves; and
at least one processor configured to:
monitor user activity of the server; and
generate the category decay curves and the user decay curves using the monitored user activity.

2. The server of claim 1, wherein at least one processor is further configured to:
receive an offer recommendation request from a first user relating to a listing of a second user, the listing associated with a category;
generate a first recommendation based on a category decay curve associated with the category;
generate a second recommendation based on a seller decay curve associated with the second user; and
generate a blended recommendation using the first recommendation and the second recommendation.

3. The server of claim 1, wherein at least one processor is further configured to:
receive an offer command from a first user relating to a listing of a second user, the listing associated with a category, the offer command having an offer price;
generate a first recommendation based on a category decay curve associated with the category;
generate a second recommendation based on a seller decay curve associated with the second user;
generate a blended recommendation using the first recommendation and the second recommendation; and
provide an offer of the offer price to the second user at a time indicated by the blended recommendation.

4. A method for temporal disposition of offers based on decay curves, comprising:
receiving an offer recommendation request from a first user relating to a listing of a second user, the listing associated with a category;
generating a first recommendation based on a category decay curve associated with the category; and
generating a second recommendation based on a seller decay curve associated with the second user.

5. The method of claim 4, further comprising:
providing the first recommendation and the second recommendation to the first user.

6. The method of claim 4, further comprising:
generating a blended recommendation using the first recommendation and the second recommendation.

7. A non-transitory computer-readable device having instructions stored thereon that, when executed by at least one computing device, causes the at least one computing device to perform operations comprising:
receiving an offer recommendation request from a first user relating to a listing of a second user, the offer associated with a category;
generating a first recommendation based on a category decay curve associated with the category; and
generating a second recommendation based on a seller decay curve associated with the second user.

8. The device of claim 7, the operations further comprising:
providing the first recommendation and the second recommendation to the first user.

9. The device of claim 7, the operations further comprising:
generating a blended recommendation using the first recommendation and the second recommendation.

10. A method for temporal disposition of offers based on decay curves, comprising:
receiving an offer command from a first user relating to a listing of a second user, the listing associated with a category, the offer command having an offer price;
generating a first recommendation based on a category decay curve associated with the category; and
generating a second recommendation based on a seller decay curve associated with the second user.

11. The method of claim 10, further comprising:
providing the first recommendation and the second recommendation to the first user.

12. The method of claim 10, further comprising:
generating a blended recommendation using the first recommendation and the second recommendation.

13. The method of claim 12, further comprising:
providing an offer of the offer price to the second user at a time indicated by the blended recommendation.

14. A non-transitory computer-readable device having instructions stored thereon that, when executed by at least one computing device, causes the at least one computing device to perform operations comprising:
receiving an offer command from a first user relating to a listing of a second user, the listing associated with a category, the offer command having an offer price;
generating a first recommendation based on a category decay curve associated with the category; and
generating a second recommendation based on a seller decay curve associated with the second user.

15. The device of claim 14, the operations further comprising:
providing the first recommendation and the second recommendation to the first user.

16. The device of claim 14, the operations further comprising:
generating a blended recommendation using the first recommendation and the second recommendation.

17. The device of claim 16, the operations further comprising:
providing an offer of the offer price to the second user at a time indicated by the blended recommendation.
